(19) United States
(12) Patent Application Publication
(10) Pub. No.: US 2015/0364274 A1
(43) Pub. Date: Dec. 17, 2015

(54) A REMOTE CONTROLLABLE SWITCH OPERATING DEVICE

(71) Applicant: DEN AUTOMATION LIMITED, Notting Hill, London (GB)

(72) Inventor: Yasser Khattak, Nottinghill, London (GB)

(21) Appl. No.: 14/763,354

(22) PCT Filed: Jan. 27, 2014
(86) PCT No.: PCT/GB2014/000027

§ 371 Date: Jul. 24, 2015

(30) Foreign Application Priority Data
Jan. 25, 2013 (GB) 1301437.8

(51) Int. Cl. H01H 9/54; H01R 13/73; H01H 23/24

(52) U.S. Cl. CPC H01H 9/54; H01H 23/24; H01R 13/73; H01H 2205/002; H01H 2221/016

(57) ABSTRACT

A Remote Controllable Switch Operating device Many household and workplace electrical appliances must be connected to a power supply. They are turned on and off by electrically connecting them to and disconnecting them from a power supply. Typically this is done manually by a user operating a switch. The present invention is directed toward a wirelessly operable electrical light switch (331) or plug socket with a switch arranged to connect and disconnect electrical power to a domestic electrical appliance (170). The device is suitable for use in a building, in a camper van, or in the living quarters of a ship and other places where domestic appliances are commonly connected to power. The device is a remote controllable switch operating device (1000) that includes a receiver (290) for receiving a control signal and an actuator (100) which responds to the control signal in order to turn a switch (330) on and off, wherein the operating device is dimensioned and arranged to retro-fit to a housing (210) with an exposed switch and the actuator is located, so that in use, it engages with the switch in order to turn the switch off or on upon receipt of a corresponding control signal.

### FIELD OF THE INVENTION

The present invention relates to switching device. More particularly the invention relates to a switching device for switching an electrical appliance on and off. The device is suitable for use in a domestic or office building, in a vehicle, such as a camper van, or in living quarters of a ship; and other locations where electrical appliances are commonly found.

### BACKGROUND

Many household and workplace electrical appliances in use are connected to a power supply. They are turned on and off by connecting to and disconnecting from the power supply. Typically this is done manually by a user operating a manual switch.

A manual switch is useful for turning on or off a light or an appliance plugged into a power socket. A person can usually see, or feel (if they are visually impaired), by the position or state of the switch, that the power supply is switched on or off, when obscured by darkness or furniture. People are familiar with using manual switches.

In some situations it may be more convenient, or even safer, to be able to control the switch remotely. For example when turning off a light, it may be safer to do so when the desired location has been reached rather than having to make ones way across a room in darkness.

As most switches are permanently located, for example on walls, they can only be controlled from their fixed location, one at a time. This can also cause an inconvenience, especially for people with limited mobility or who are bed-ridden. For example a light cannot be turned on and off if the mechanical switch is out of reach to such a person.

Another problem is in large houses, a person has to walk around the building or house turning all lights and appliances off one at a time, at night, typically before going to bed.

Because of the limitations of switches available in the prior art, appliances tended to be left switched on, so wasting energy or left switched on posing a risk of electrical fire or electrical accident. Appliances also tended to be left switched off because a switch to turn on the appliance could not be seen or found easily in the dark or because a timer switch had tripped.

Thus there is a need for a switch operating device which retains the usefulness of a manual switch and overcomes the aforementioned problems.

### PRIOR ART

A number of patent applications have been filed in an attempt to resolve the aforementioned or similar problems.

Chinese utility model CN 201 585 173 (YI et al) relates to a wireless lighting switch, which comprises a control panel and a far infra-red (IR) transmitter.

Similarly International patent application WO 2008 063 283 (SPIRA) discloses a lighting control system comprising: a remotely-controllable load control device, such as dimmer switch.

Remote controlled lighting was available, in the form of timer switches; however some required light fittings to be replaced with specialist parts which were often costly. Another problem with timer switches was that they were inflexible and did not permit any immediate control because the timings had to be preset.

The invention arose in order to overcome the problems associated with the prior art and to provide an improved switch operating device that overcomes the aforementioned problems.

### SUMMARY OF THE INVENTION

According to the present invention there is provided a remote controllable switch operating device includes a receiver for receiving a control signal from a remote control device and an actuator which responds to the control signal in order to turn a switch on or off, characterised in that the switch operating device is dimensioned and arranged to retro-fit to a housing with an exposed switch and the actuator is located, so that in use, the actuator engages with the switch in order to turn on the switch or to turn off the switch, upon receipt of a corresponding control signal.

Preferably a switched interface comprises the housing, the switch, and electrical connector for an appliance so that advantageously the operating device connects or disconnects electricity to the electrical connector so as to turn it ‘on’ or ‘off’.

According to a second aspect of the present invention there is provided a remote controllable switch operating device including: a receiver for receiving a control signal from a remote control device and an actuator which responds to the control signal in order to turn a switch on or off, characterised in that at least a portion of the switch is exposed so as to permit manual operation of the switch.

Preferably the remote controllable switch operating device is dimensioned and a [symbol] to a housing comprising the switch arranged [symbol] operation.

There is ideally a provided an operating device for supplying a remote control signal to the switch operating device which is battery powered and is ideally portable. However, it is understood that mobile communication devices fitted with an infra-red communication port may be configured to act as a remote controller by providing a suitable signal. Such a mobile communication device may be a portable digital assistant (PDA), a Blackberry (Trade Mark) mobile device, an i-Phone (Trade Mark) or any similar device that is capable of operating according to a computer programme to generate and transmit a suitable control signal.

Advantageously the remote controllable switch operating device provides a manually displaceable mechanical switch, preferably in the form of a rocker, turnable knob or toggle which is manually displaceable or repositionable. Ideally the operating device displaces the switch from one position and state (on or off) to another position and state (on or off) in accordance with a desired control signal. So that when the switch is being remotely operated the switch moves or is displaced in order to open or close a circuit.

Preferably the same switch that is manually operable by displacement or repositioning is also remotely operable by the actuator acting in accordance with the control signal. Remote operation of the switch physically changes the switch position. The change in position can be observed by a user who may operate the switch manually.

As preferably the actuator physically displaces the switch upon turning the switch ‘on’ or ‘off’ a user can see it is in the ‘on’ or ‘off’ position.

In a second embodiment the remote controllable switch operating device is clamped or connected to an exterior of a switch interface or housing. Preferably the switch, which is exposed on the switch interface, remains exposed or partially exposed when the remote controllable switch operating device is clamped into place. A user can turn the switch ‘on’ or ‘off’ remotely without touching the switch. A user can also turn the switch ‘on’ or ‘off’ manually by touching and manually displacing the switch because the switch is exposed.

In some examples of the second embodiment the remote controllable switch operating device is clamped to a switch interface and covers the switch. In this instance a window or a light, light emitting diode (LED) or another indicator is provided on the remote controllable switch operating device so that the user can see that the switch has been displaced by turning it ‘off’ and ‘on’.

Advantageously the present invention provides a means for allowing remote control of electrical outlets, sockets, fasciae, or appliances. The remote controllable switch operating devices may be incorporated into such appliances either at manufacture or aftermarket.

In some embodiments the clamp consists of first and second clamp parts which are displaceable in use relative one to another. The clamp parts may be secured with a spring bias acting to force the clamp parts together or to urge the clamp parts onto a fascia or switch housing.

In other preferred embodiment the operating device is integrated into a housing or fascia so that components are hidden.

The operating device comprises a first component part which includes an actuator that is adapted to displace the switch. Optionally a second component part is secured to an electrical back box, in this configuration the component parts are secured together in use.

In some such embodiments the second part may be screwed onto or into the back box so as to push against the first part, wherein said first part is mounted on or comprises the fascia. Electrical connection may in addition be made from or via the second part. In other embodiments where the operating device is integrated into the fascia, or switch, the parts may be formed integrally or made to connect inseparably in use or after installation.

Advantageously in embodiments where the operating device is suitable for retro-fit to operate a pre-installed switch, the operating device is integrated in the fascia so that the fascia remains usable in standard localized format, wherein ideally the operating device is incorporated into a rear face of the fascia for example with no impact on the aesthetics of the fascia.

Ideally the actuator is arranged to displace the switch in such a manner that the position or state of the switch may be reversed or changed manually. Advantageously the switch is operable via the remote controllable switch operating device from a remote location such as another room.

When the switching device is integral with a switch housing behind a fascia, the switch can be considered to be internally activated or deactivated, whereas when operated manually the switch may be considered to be exteriorly activated.

Ideally the control signal can be transmitted to ranges of up to several hundred metres so as be able to control the operating device even when outside of a home, for example to switch on lights when arriving home.

Preferably the remote controller is incorporated into existing hardware, which may be operable or function using software or firmware. For example therefore in some embodiments the remote controller may be provided by or as a function of a ‘smart-phone’, such as an ‘APP’ or in a universal controller.

Ideally the operating device and remote controlled are first synchronised together so as to be able to send and receive information between the two. Once synchronised the operating device and remote controller may communicate by transmission and acceptance of wireless signals.

Typically fasciae project from walls on which they are mounted so as to be proud of the wall. Therefore for externally mounted or retro-fit embodiments the operating device parts may be shaped so as to bridge, encompass or cover at least part of the fascia ideally by having extended end portions that hook over the fascia sides so as to clamp or secure to the fascia without requirement for an additional means of fitting.

Preferably the operating device vertically traverses the fascia so as to be positioned over the switch or switches. It is envisaged that the buttons may remain depressed when pressed so as to visually indicate what state the device is in for example, on or off.

Advantageously the operating device may be adapted to fit single and double fasciae. For example for double switches additional buttons may be included to control the second switch.

Preferably the operating device for the single switch includes an extended side edge so as to fit to the fascia top, bottom (as in the double adapter) and side.

Typically as the single operating device is offset, so as to cover the single switch, the adapter enclosing the side as well as the top and bottom may provide better fit and neater appearance.

In devices that are retro-fitted to the fascia an integral battery provides the means of power to control the device. Yet further embodiments which connect to the electrical current may include a false front and/or may allow the device to provide a socket or physical switch.

Preferably the operating device is inbuilt, embedded or permanently fastened to the fasciae, for example so as to allow the operating device and system to operate in fasciae that may not accept the spring fit mechanism. In some embodiments the operating device is fitted around fasciae, for example by a resiliently deformable member, flexible or elastic strap.

In preferred embodiments actuator moves quickly in order to move the switch without protracted movement against the connection means.

Preferably the operating device may also operate from mains power, removing and reducing requirement for batteries.

Preferably the operating device is included in a fascia, wherein the actuator acts on the switch to connect or disconnect electrical current to an electrical circuit or outlet.

The invention will now be described, by way of example only, with reference to the accompanying drawings in which:

### BRIEF DESCRIPTION OF THE FIGURES

FIG. 1 shows a schematic view of a room wherein a user operates the remote controllable switch operating device to turn on and off a light and a television;

FIG. 2 shows a schematic view of a first embodiment of the device arranged within a single part;

FIG. 3 shows a schematic view of a second embodiment of the device arranged as two parts securable to a housing comprising a switch;

FIG. 4 shows an isometric view of a first example of the second embodiment of the operating device in use on a fascia;

FIG. 5 shows a rear isometric view of the first example of the second embodiment of FIG. 4 in use on a fascia;

FIG. 6 shows an isometric view of a second example of the second embodiment of the operating device in use on a fascia;

FIG. 7 shows an isometric view of a carcass of the second example of the second embodiment shown in FIG. 6;

FIG. 8 shows a rear isometric view of a the first embodiment of the operating device integrated into a fascia;

FIG. 9 shows an exploded isometric view of a third example of the second embodiment of the operating device;

FIG. 10 shows an isometric view of an embodiment of the remote controller; and

FIG. 11 shows a rear isometric view of the second example of the second embodiment of FIG. 6 in use.

### DETAILED DESCRIPTION OF PREFERRED EMBODIMENTS OF THE INVENTION

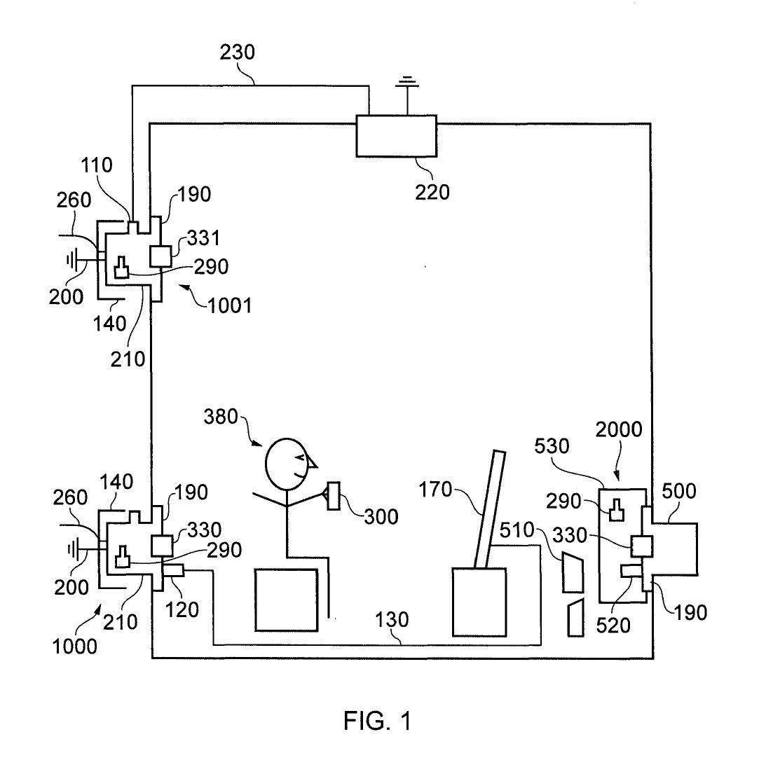

FIG. 1 shows a schematic view illustrating the remote controllable switch operating device in use.

A user 380 is sitting in a chair and holding a remote controller 300. The user uses the remote controller to provide a control signal two turn on and off the remote controllable switch operating device 1000 by which electricity is supplied to the user's television 170.

The user 380 also uses the remote controller 300 to provide a control signal that turns on and off the remote controllable switch operating device 1001 by which electricity is supplied to a light 220 in the room.

An appliance wire 130 is connected to the television 170. The appliance wire has a plug 120 that is plugged into a socket in the remote controllable switch operating device 1000.

If the user 380 prefers they can manually operate the switch 330 to turn on and off the electricity supplied to the television. The switch 330 is exposed to the user so that the user can move it.

If the user 380 uses the remote controller 300 to turn off or on the electricity to the television 170, the switch 330 is physically moved by an actuator within the remote controllable switch operating device 1000.

A light wire 230 is connected to the light 220. The light wire is also connected to an appliance connector on the remote controllable switch operating device 1001.

The user 380 has a choice of either manually operating the switch 331 on the operating device 1001 to turn on and off the electricity supplied to the light 220 or using the remote controller 300 to turn on and off the electricity supplied the light. If the user chooses to use the remote controller to turn the light on or off the switch is physically moved by an actuator within the operating device.

Each operating device 1000, 1001 has a receiver 290 that receives a control signal provided by the remote controller 300. The remote controller 300 provides a wireless signal and the receiver 290 is a wireless receiver. A portion of the receiver may be external to the operating device so as to receive clearly either an electromagnetic radio signal, a visible or invisible light signal, or an audible or inaudible sound signal that commands the operating device to turn the switch 330, 331 on or off.

The operating device 1000, 1001 has a housing 210 that is dimensioned and arranged to be received by an electrical back box 140 used for building electrical wiring.

The housing 210 comprises a mains power connector which is connected to a power cable 260 and a ground cable 200.

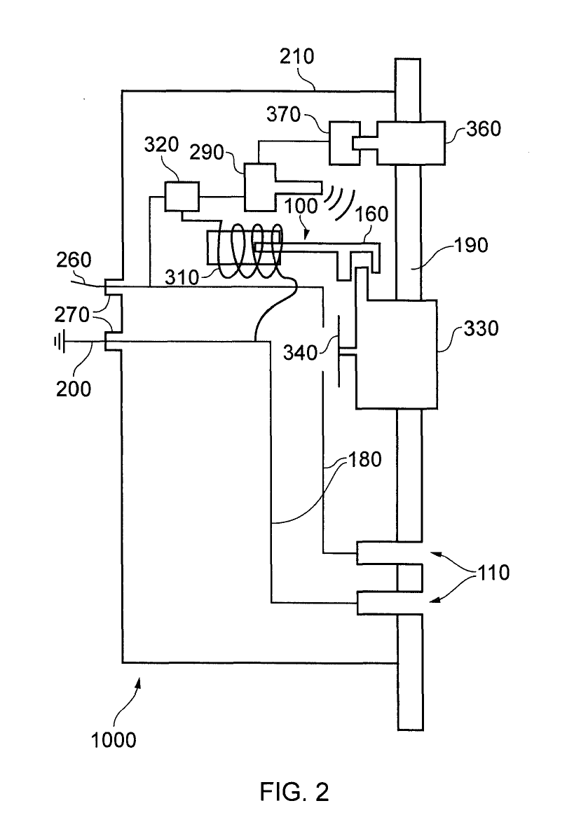

FIG. 2 shows a schematic of the first embodiment of the operating device. A switch 330 protrudes through a fascia 190. The switch 330 is exposed to a user who can see and touch the switch 330 where it protrudes through the fascia 190.

The user displaces the switch 330 to move electrical contacts 340. By bringing the contacts 340 into contact with the terminals of an electrical circuit 180, the electrical circuit 180 is closed. The user displaces the switch 330 to open and close the circuit 180.

As shown in FIG. 2, the electrical circuit 180 connects a power supply connector 260 to an electrical appliance connector 110. The appliance connector 110 is a socket suitable for receiving plug 120 as the one illustrated in FIG. 1 at the end of the television appliance wire 130. The power supply connector is adapted to connect to a power cable 260. The power cable 260 is part of mains electrical wiring in a building. A terminal of the socket 110 is also connected directly by the circuit 180 to a ground cable 200. A power supply connector 270 is arranged to simplify connection of the operating device to the power cable 260 and the ground cable 200.

When the user moves the switch 330 to close the circuit 180 the appliance connector 110 is turned on. An appliance 170 having a plug 120 in appliance connector is thereby connected to the mains electrical supply. When the user moves the switch 330 to open the circuit 180, the appliance connector 110 is electrically disconnected from the power cable 260.

The remote controllable switch operating device 1000 is protected by a housing 210 and covered by a fascia 190. The housing and the fascia are shown as separate components in FIG. 2, but they can be a single piece.

When the operating device 1000 is installed into a building wall, the fascia is arranged to face a user.

A receiver 290 enables the operating device to detect control signals. The receiver 290 is electrically connected to a solenoid relay 320. The solenoid relay is connected to the power supply connector 270 and also connected to a solenoid 310.

The solenoid 310 drives a displaceable member 160 and so together are an actuator 100. The skilled person could substitute another type of electro-magnet as the actuator.

The displaceable member 160 holds the switch 330 so that when the displaceable member moves the switch 330 also moves. Thus the switch 330 is displaced by operation of the actuator 100.

Although typically the actuator 100 comprises a solenoid 310 and the circuit 180 is opened and closed by the actuator 100 displacing or depressing a switch 330 in the form of a button or a rocker, other types of electro-mechanical transducers are known and may be substituted. A motor with a worm gear is another example. A force is generated by the solenoid 310, which may be a linear solenoid as shown in FIG. 2. The solenoid creates an electromagnetic field that moves the actuator or a plunger 160 in order to press the switch 330. Typically the plunger 160 moves parallel to the switch 330 so as to engage with and push up the switch when extended and pull the switch down when retracted.

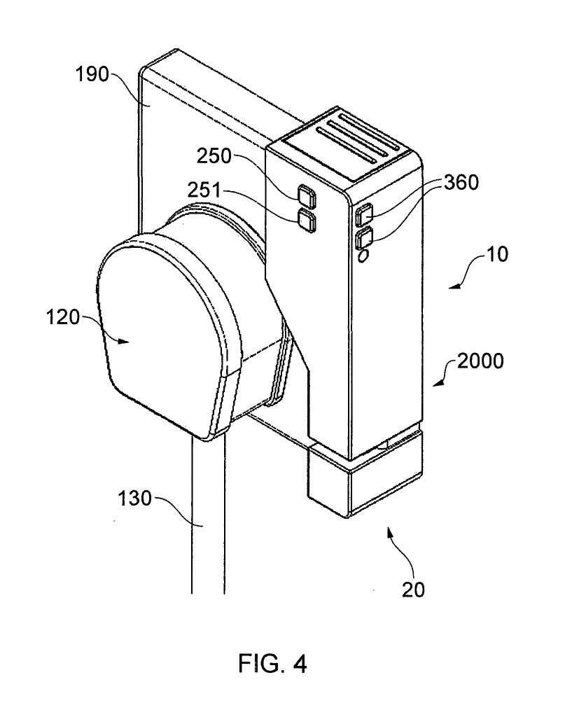

In some examples of the operating device 1000, 2000 there are actuator buttons on the fascia 190 or the exterior casing 530 to operate the actuator so as to turn the switch 330 on and off. In FIG. 4 an ‘on’ button 250 and an ‘off’ button 251 are shown. The actuator button is also exposed from the fascia and the solenoid may also be activated manually by pressing the actuator button.

Activation of the actuator in preferred embodiments produces a controlled linear force to toggle the switch from on to off, typically mimicking an action of a user pressing the switch. Thus remote activation via the receiver 290 mimics the action of a user's manual displacement of the switch 330.

Ideally the solenoid 310 may be activated by the signal received from the remote controller 300 which passes the signal to the operating device. The signal may be envisaged to be transmitted by infra-red, shortwave radio frequency, wireless connectivity or inter-machine operability such as Bluetooth (Trade Mark).

Scrutinizing FIG. 2 in detail it is evident that a user 380 turns the switch on remotely by commanding a remote controller 300 to send a wireless ‘on’ command signal. The ‘on’ signal is detected and interpreted by the receiver 290. The receiver 290 is electrically connected the solenoid relay 320 and activates the relay to operate the actuator 100 to move the switch 330 to the closed position. The electrical contacts 340 then close the circuit 180 to provide electricity to an appliance 170 connected to the appliance connector 110.

A user can also see that the switch has been moved to the ‘on’ position because the switch is exposed where it protrudes through the fascia 190.

A user 380 turns the switch off remotely by commanding a remote controller 300 to send a wireless ‘off’ command signal. The ‘off’ signal is detected and interpreted by the receiver 290. The receiver 290 is electrically connected the solenoid relay 320 and activates the relay to operate the actuator 100 to move the switch 330 to the open position. This disconnects the electrical contacts 340 from the circuit 180 to prevent electricity flowing to the appliance connector 110. A user can also see that the switch 330 has been moved to the ‘off’ position because the switch is exposed where it protrudes through the fascia 190.

The signal is received by the receiver 290 which comprises or is electrically connected to a signal interpretation circuit which may be on a printed circuit board (PCB). The interpreted signal is used to produce the desired response, for example to turn on or off the switch 330.

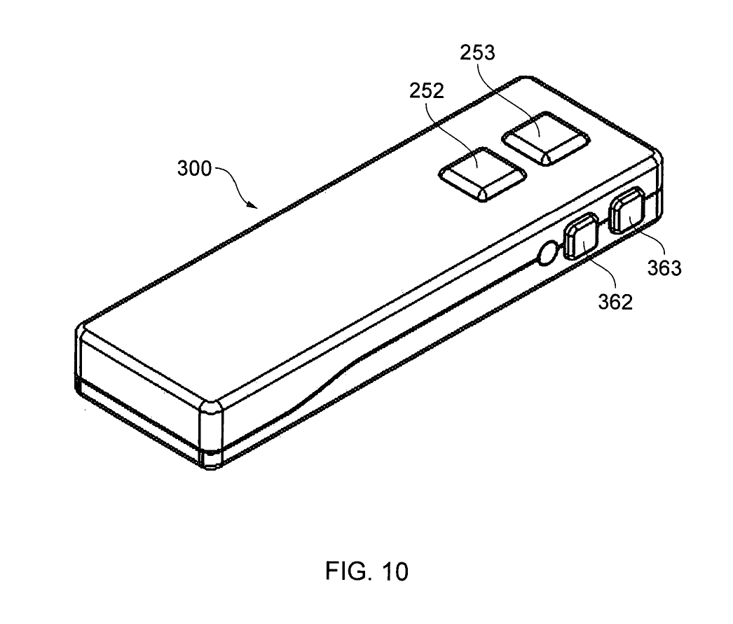

The remote controller 300 in some examples is a familiar rectangular object or casing as shown in FIG. 10. The remote controller is equipped to send a transmission to the operating device when activated and including its own power supply in the form of the battery. It is envisaged that the remote controller may be handheld or wall mounted. The remote controller 300 comprises an ‘on’ button 252 and an ‘off’ button 253. In another example of the remote controller 300 it comprises a microphone by which it is voice activated. The remote controller wireless transmits the corresponding ‘on’ or ‘off’ command signal when the corresponding button is pressed preferably by radio waves. The interpretation circuit identifies and interprets the signal triggering activation of the solenoid 310 so as to engage the plunger 160 which in turn depresses the switch 330.

In an alternative configuration of the remote controlled switch operating device 1000, the user's voice acts as the remote controller. The receiver 290 is an audible sound detector and the interpretation circuit interprets the words ‘on’ and ‘off’.

The remote controller 300 comprises syncing buttons 362 and 363. Depressing a sync button on the remote controller causes it to issue wireless sync signal that is detected by the receiver 290 in the operating device.

To make the remote controller 300 operate a particular remote controller switch operating device 1000, 1001, 2000, the sync button 360 on the operating device is depressed and simultaneously the sync button 362 is depressed on the remote controller. Both buttons are held down for a predetermined time.

A sync circuit 370 shown in FIG. 2 is activated by depressing the sync button 360. The sync circuit is electrically connected to the receiver 290. Depressing the sync button 360 on the operating device 1000 while the sync button 362 is depressed causes the operating device 1000 and the remote controller 300 to by synced. Once the remote operating device 1000 and the remote controller are synced, the syncing circuit 370 permits ‘on’ and ‘off’ commands to be transmitted by the receiver 290 to the solenoid relay 320, so the remote controller 300 operates the switch 330. To unsync the remote controller and the operating device the unsync buttons 361, 363 on the remote controller and operating device are simultaneously depressed for a predetermined time.

If one user remotely alters the position of the switch 330 while another user is manually altering the position of the switch, the actuator will recognize this and will allow the remote command signal to be over ridden by the user moving the switch 330 manually—this is to avoid breakage etc—actuator recognizes the force acting against it and will therefore stop resisting any manually imposed moving of the switch 330.

The arrangement of the appliance connector 110, power supply connector 270, circuit 180, electrical contacts 340, switch 330, actuator 100, solenoid relay 320, receiver 290, housing 210, fascia 190 and so forth are shown for example in FIG. 2 for a first embodiment of the device. An arrangement of these components has been described in the paragraphs above. This arrangement also generally applies to other embodiments where practical except where the other embodiments are described as differing from the first.

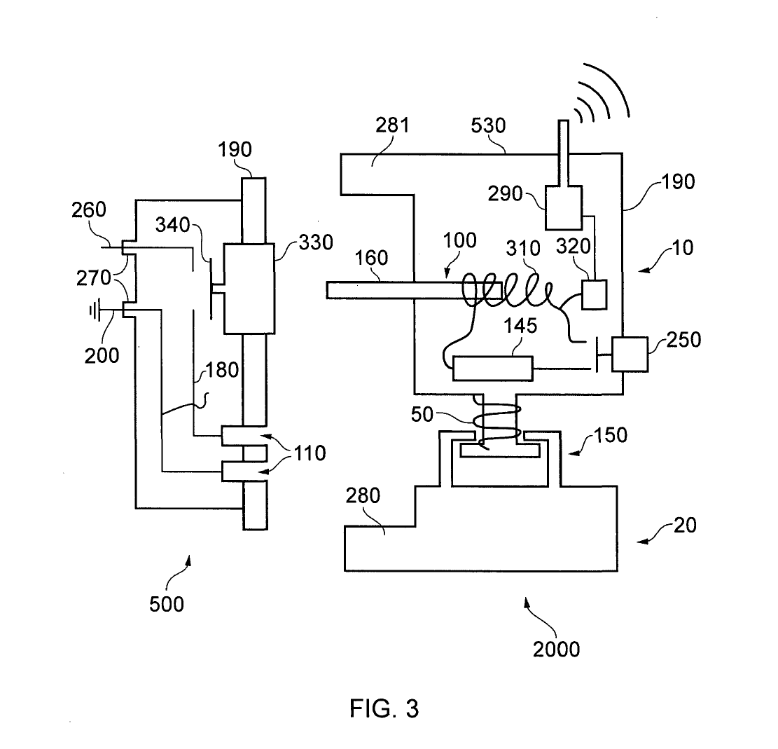

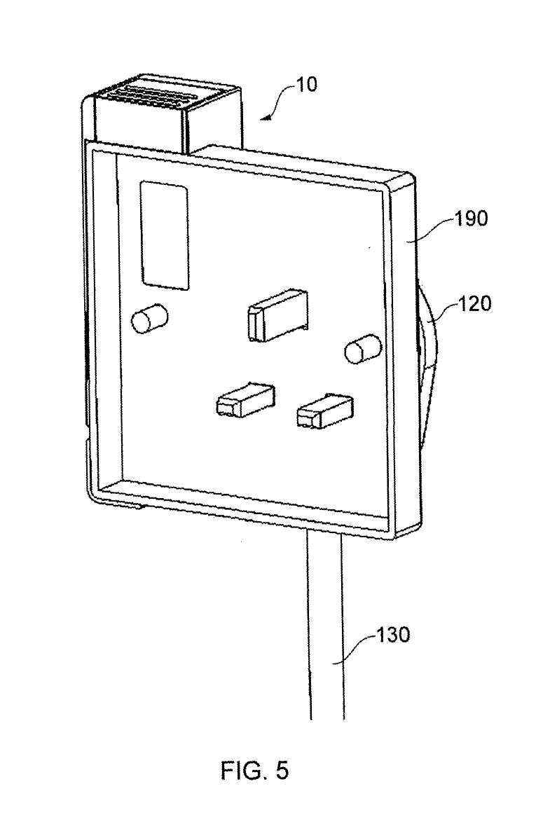

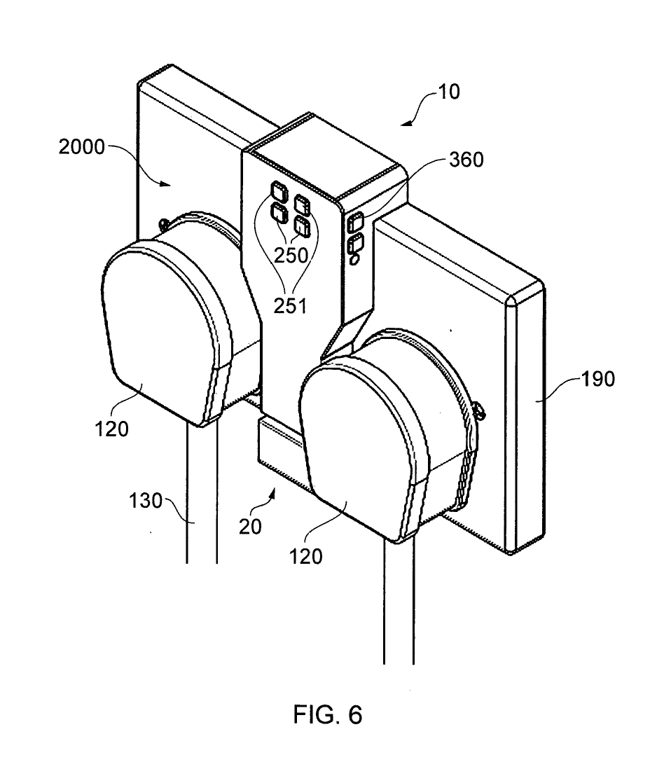

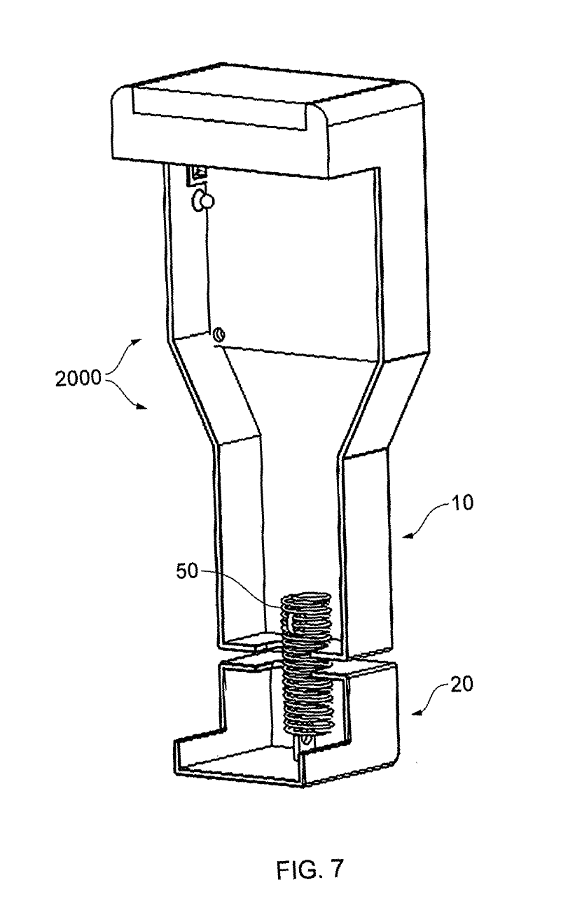

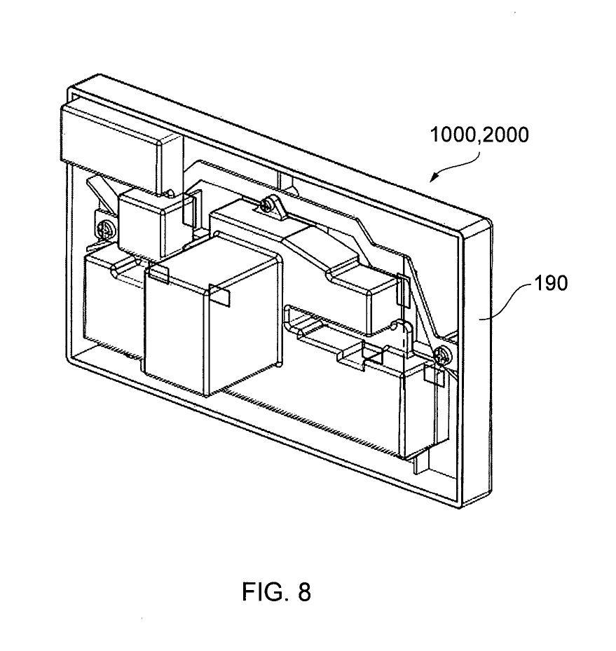

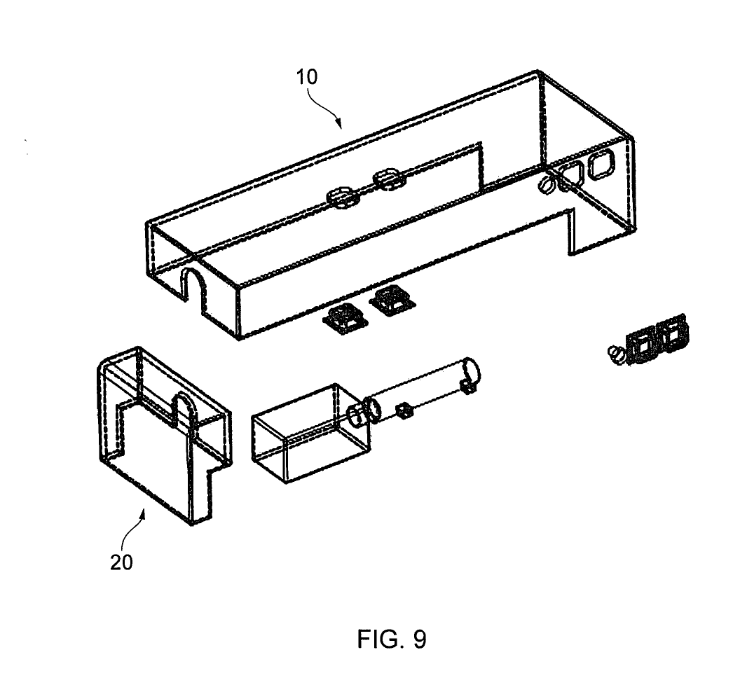

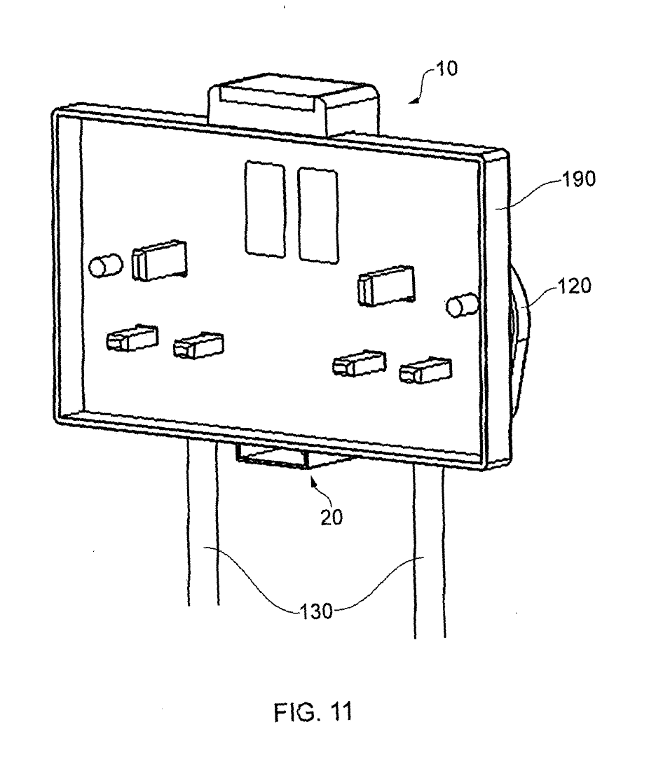

A second embodiment of the remote controllable switch operating device is shown in FIG. 3, FIG. 4, FIG. 5, FIG. 6, FIG. 7, FIG. 9, and FIG. 11. FIG. 8 shows a hybrid embodiment of the first and second embodiments in combination.

FIG. 3 shows a schematic view of the second embodiment of the remote controllable switch operating device 2000.

FIG. 4 shows a first example of the second embodiment of the operating device 2000 attached to a fascia of a switched interface 500. The switched interface 500 comprises a switch 330 which turns off and on electrical power to an appliance connector 110. Generally the appliance connector is a plug socket as shown in FIGS. 4 and 6.

Homes and offices are typically built with switch interfaces 500 which comprise a manually operable switch 330 to turn on and off electricity to a socket 110 in the interface or to turn on and off electricity to an appliance connector 110 that is connected to a light wire 230.

The second embodiment of the operating device 2000 is an external embodiment because it clamped the exterior of a switch interface 500. The second embodiment of the invention 2000 is arranged to clamp onto the fascia 190 of the switch interface 500.

In one example of the second embodiment shown particularly in FIG. 3, FIG. 4, and FIG. 6 the operating device 2000 comprises a first part 10 adapted to be secured in use to a second part 20; wherein the parts 10, 20 are adaptable to secure the operating device 2000 to the fascia 190 of the housing of the switch interface 500. Thus the operating device 2000 is dimensioned and arranged to retro-fit to the part of the housing of the switch interface 500 which is the fascia 190. The fascia comprises the switch 330.

The second embodiment of the operating device 2000 is typically attached to the fascia 190 by means of the sprung mechanism 150. By the sprung mechanism 150, the second part 20 is displaceable relative to the first part 10. Both parts may be pulled apart by stretching the spring so as to enable the parts to traverse the fascia. The clamping mechanism 150 spring 50 draws the two parts 10, 20 together, thereby clamping the operating device 2000 to the fascia 190 of switch interface 500 housing.

The second embodiment of the operating device 2000 includes with the first part 10, a receiver 290 for receiving a control signal and an actuator 100 which responds to the control signal in order to turn the switch 330 on and off.

The switch 330 is exposed so that it is manually operable by the user. When the operating device 2000 is clamped to the fascia 190 for use, the actuator 100 is located so that it engages with the switch 330 in order to turn the switch 330 off or on upon receipt of a corresponding control signal.

In external embodiments of the operating device 2000 arranged for use exterior to the switch interface 2000, the operating device 2000 typically comprises a casing 530 that houses at least two sets of buttons for controlling the operating device 2000. One set of buttons enables syncing of the operating device with a remote controller 300. The second set of button is for manual operation of at least one switch 330. The casing 530 houses a solenoid which produces motion when activated so as to toggle switch 330 between on and off. The casing 530 houses an interpretation circuit on a printed circuit board (PCB) to receive and interpret signals received by the receiver 290 also housed by the casing 530.

In the second embodiment of the operating device 2000, there is at least one battery inside the casing 530.

The second embodiment of the operating device 2000 cooperates with a remote controller 300 capable of transmitting a signal to the operating device to remotely operate the switch 330.

The second embodiment of the remote controllable switch operating device 2000 works for a user 380 as the first embodiment does. In the illustration of FIG. 1 the user commands a first embodiment of the operating device 1000 to turn on and off electricity to a television. The use also commands a second embodiment of the operating device 2000 to turn on and off electricity to an electric socket which is connected to a radio wire plug 520 so as to turn on and off a radio 510.

The arrangement of the receiver 290, solenoid relay 320, actuator 100, solenoid 310, displaceable member 160 inside the casing 530 of the second embodiment is as described for the first embodiment except that the battery 145 provides power for the actuator 100, receiver 290, and solenoid relay rather than power cable 260 in the first embodiment.

Ideally two sets of buttons are positioned in different locations user accessible locations on the exterior of the operating device. Activation buttons are positioned on the face of the operating device, above the fasciae so as to be easily accessible. One set of activation controls or buttons enable the operating device 1000, 2000 to synchronize with the remote controller 300. They are positioned on the operating device side where they are clearly distinguishable. In some further embodiments such activation controls may be permanently open or may have a time delay open period during which synchronization may be achieved. In such embodiments the controls may be hidden in use.

In preferred embodiments the operating device and remote controller may be formed of same or similar materials as that of the fasciae so as to be discrete such as synthetic plastic or brushed stainless steel.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

1. A remote controllable switch operating device includes a receiver for receiving a control signal from a remote control device and an actuator which responds to the control signal in order to turn a switch on or off, characterised in that at least a portion of the switch is exposed so as to permit manual operation of the switch.

2. An operating device according to claim 1 is dimensioned and arranged to retrofit to a housing comprising the switch arranged exposed for manual operation.

3. An operating device according to claim 1 wherein the actuator physically displaces the switch upon turning the switch ‘on’ or ‘off’.

4. A remote controllable switch operating device includes a receiver for receiving a control signal from a remote control device and an actuator which responds to the control signal in order to turn a switch on or off, characterised in that the switch operating device is dimensioned and arranged to retro-fit to a housing with an exposed switch and the actuator is located, so that in use, the actuator engages with the switch in order to turn on the switch or to turn off the switch, upon receipt of a corresponding control signal.

5. An operating device according to claim 4 wherein the switch is exposed so as to permit manual operation of the switch.

6. An operating device according to claim 1 includes a power supply connector adapted to connect the device to a mains power supply.

7. An operating device according to claim 1 includes an appliance connector for connecting the device to an electrical appliance.

8. An operating device according to claim 5 wherein the switch is a displaceable switch arranged to open in order to switch an electrical circuit to open circuit and to close in order to complete an electrical circuit.

9. An operating device according to claim 1 wherein the actuator is an electro-mechanical device arranged to displace the switch to the ‘on’ and the ‘off’ or the off position with power provided by the power supply via a connection to an electrical circuit.

10. An operating device according to claim 1 has a fascia with an aperture to reveal the switch.

11. An operating device according to claim 1 comprising: a first part having a displaceable member adapted in use to be secured to a second part; wherein the parts are capable of being secured to a housing.

12. An operating device according to claim 11 wherein the second part is displaceable in use relative to the first part, use that the parts are connected with spring bias acting to urge the parts together.

13. An operating device according to claim 4 adapted to clamp onto a switch interface or socket front covering.

14. An operating device according to claim 1 wherein the operating device is inbuilt, embedded or formed with a fascia.

15. An operating device according to claim 1 wherein the switch is a rocker switch.

16. A system comprising an operating device according to claim 1 and a remote controller arranged to provide an on and/or an off signal to the receiver.

17. (canceled)
